(19) United States
(12) Patent Application Publication
(10) Pub. No.: US 2012/0005677 A1
(43) Pub. Date: Jan. 5, 2012

(54) Computing Machine and Method for Controlling Computing Machine

(76) Inventor: Yuji Fujiwara, Hamura-shi (JP)

(21) Appl. No.: 13/100,814

(22) Filed: May 4, 2011

(30) Foreign Application Priority Data
Jun. 30, 2010 (JP) 2010-150343

(51) Int. Cl. G06F 9/455

(52) U.S. Cl. 718/1

(57) ABSTRACT

According to one embodiment, a computing machine includes an activation module configured to activate, in a first mode, a virtual machine using a first virtual storage includes a basic virtual storage file, an update differential virtual storage file, and a change differential virtual storage file, a allocating module configured to allocate a second virtual storage includes a data storage virtual storage file to the virtual machine, and a changing module configured to change the updating portion data in the update differential virtual storage file to unchanged portion data indicating a unchanged portion of the basic virtual storage file when the virtual machine is terminated, and to delete the updating data from the differential information in the update differential virtual storage file.

### CROSS-REFERENCE TO RELATED APPLICATIONS

This application is based upon and claims the benefit of priority from Japanese Patent Application No. 2010-150343, filed Jun. 30, 2010; the entire contents of which are incorporated herein by reference.

### FIELD

Embodiments described herein relate generally to a computing machine on which a virtual machine is embodied and a method for controlling the computing machine.

### BACKGROUND

Conventionally, ACL is set to prohibit “C:\” from being written under user permission, thereby prohibiting files from being stored in any place except “C:\Users.”

However, if a user has administrator permission, the writing cannot be prohibited. Even if the user does not have the administrator permission, a write-enabled folder is present. Further, if a reverse point (junction point) or the like is used, writing is possible.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram showing a structure of a computing machine system according to a first embodiment.

FIG. 2 is an exemplary block diagram showing a structure of a computing machine according to the first embodiment.

FIG. 3 is an exemplary diagram showing a structure of disks managed by an operating system executed in a virtual machine according to the first embodiment.

FIG. 4 is an exemplary diagram showing a virtual hard disk file constituting the disk according to the first embodiment.

FIG. 5 is an exemplary flowchart showing processing by a Windows (registered trademark) service after a file constituting a virtual hard disk according to the first embodiment is distributed.

FIG. 6 is an exemplary flowchart showing processing executed in the activated virtual machine according to the first embodiment.

FIG. 7 is an exemplary flowchart showing a processing procedure of virtual software on the activation and end of the virtual machine according to the first embodiment.

FIG. 8 is an exemplary flowchart showing a procedure of a Windows service operation processing for enabling an update program to be installed from a Microsoft Update or Windows Update site according to a second embodiment.

FIG. 9 is an exemplary diagram showing virtual hard disk files constituting disks according to a third embodiment.

FIG. 10 is an exemplary flowchart showing a procedure of a Windows service processing in the disk structure shown in FIG. 9.

### DETAILED DESCRIPTION

Various embodiments will be described hereinafter with reference to the accompanying drawings.

In general, according to one embodiment,

a computing machine includes an activation module, a allocating module, and a changing module.

The activation module is configured to activate, in a first mode, a virtual machine using a first virtual storage comprising a basic virtual storage file, an update differential virtual storage file, and a change differential virtual storage file, the basic virtual storage file including first data for executing an operating system and/or an application executed in the virtual machine, the update differential virtual storage file including differential information comprising updating data for updating the operating system and/or the application and updating portion data indicating a first changed portion of the basic virtual storage file which is changed by the updating data, and the change differential virtual storage file comprising changing data and changed portion data indicating a second changed portion of the basic virtual storage file and the update differential virtual storage file which is changed by the changing data. The allocating module is configured to allocate a second virtual storage comprising a data storage virtual storage file to the virtual machine. The changing module is configured to change the updating portion data to unchanged portion data indicating a unchanged portion of the basic virtual storage file when the virtual machine is terminated, and to delete the updating data from the differential information.

### First Embodiment

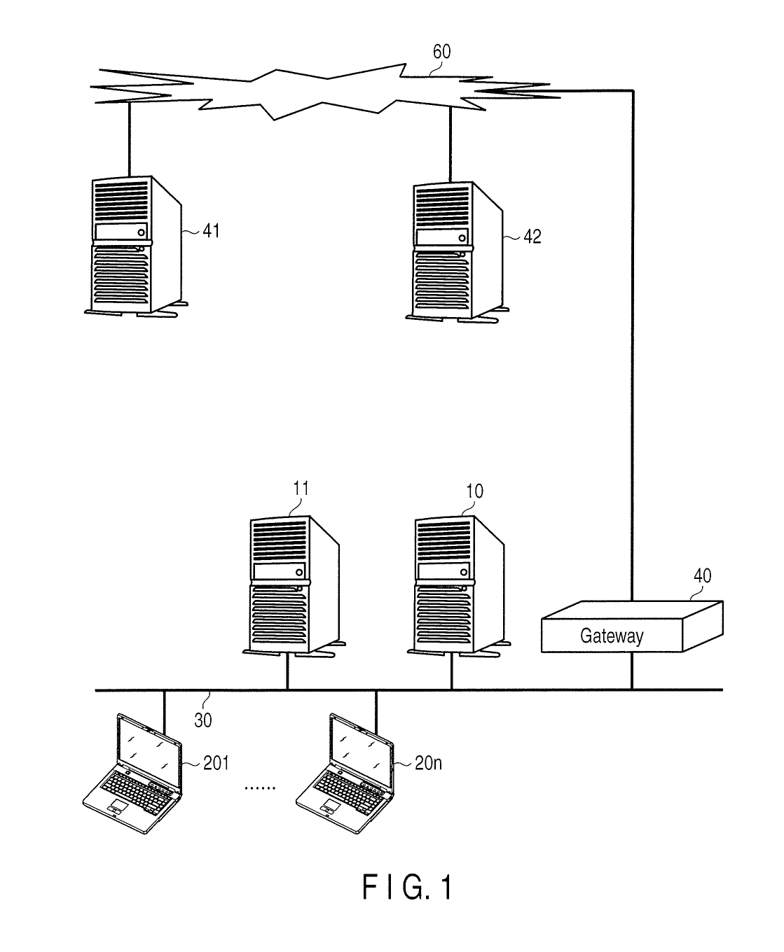

FIG. 1 is a block diagram showing a structure of a computing machine system according to a first embodiment.

An office network 30 in an office is connected with a WSUS server 10, a management server 11, a plurality of client computing machines 201 to 20n, and the like. The office network 30 is connected to an external network 60 via a gateway 40. The external network 60 is connected with an update program/catalog file distribution server 41 and an update program distribution server 42.

The WSUS server 10 periodically (once a day, for example) accesses the update program/catalog file distribution server 41 to acquire an update program/catalog file from the update program/catalog file distribution server 41 and to store the update program/catalog file in its own storage device. The update program/catalog file stores information for acquiring an update program therein.

The update program/catalog file distribution server 41 and the update program distribution server 42 are managed by Microsoft Corporation. When the update programs for the Microsoft products such as Windows or Microsoft Office are released, Microsoft Corporation updates the update program/catalog file. The update program distribution server 42 is installed for distributing the update programs registered in the update program/catalog file.

When the update program/catalog file is updated from the WSUS server 10, the client computing machine 20 (201 to 20n) acquires a new update program/catalog file. Then, an update program registered in the acquired update program/catalog file is acquired from the update program distribution server 42 and the update program is used to correct a code of an operating system or application program.

The management server 11 stores therein an image file for executing a virtual machine by the client computing machine 20. The client computing machine 20 acquires an image file from the management server 11 on activation thereby to execute the virtual machine. The operating system executed inside the virtual machine is operated by Microsoft Windows, for example. Microsoft Office operates as an office application program on Windows.

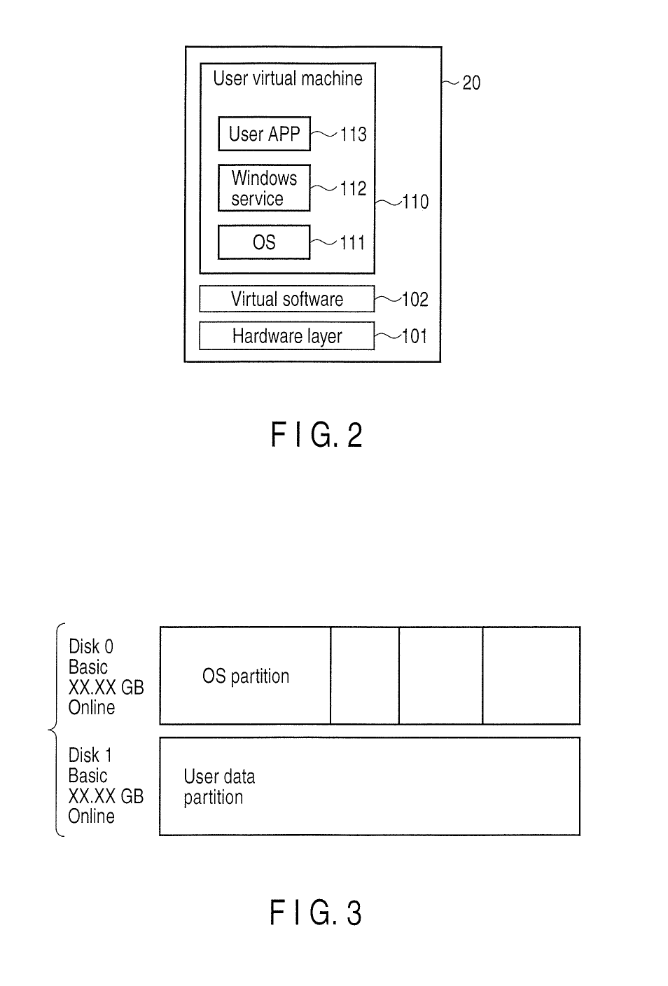

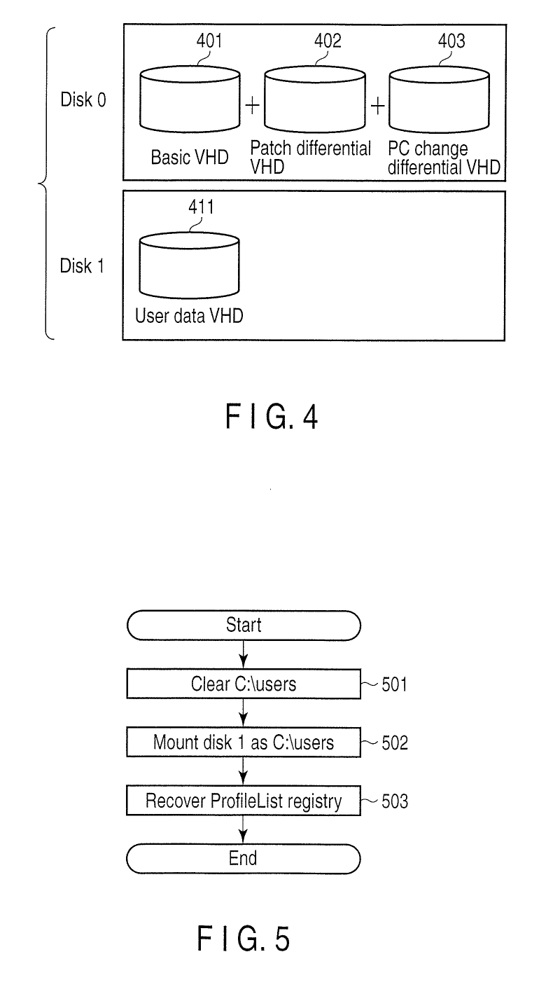

A structure of the computing machine according to the first embodiment will be first described with reference to FIG. 2. The computing machine 20 (201, . . . , 20n) can execute virtual monitor provided in XEN or VMWARE, for example.

The computing machine 20 has a hardware layer (computing resource) 101, virtual software 102 and a user virtual machine 110.

The hardware layer 101 includes a display, a hard disk drive (HDD), a network interface card, a keyboard and a mouse.

The virtual software 102 manages the hardware layer 101 to perform resource allocation on the virtual machine 110. The virtual software 102 logically divides the hardware layer (computing resource) 101 into multiple pieces and allocates each virtual machine thereto, and sorts an execution schedule of each virtual machine and an I/O request from the virtual machine to the hardware layer 101.

In the user virtual machine 110, an operating system (OS) 111, a Windows service 112 and an application (APP) 113 operate. The operating system 111 is directed for providing an environment generally used by the user. Typically, the operating system 111 employs a Windows (registered trademark) operating system.

The Windows service 112 executes a specific function without user's awareness. The Windows service 112 is automatically activated as needed when the operating system 111 is booted, and always operates in the background while the operating system is operating. The application 113 operates on the operating system 111.

The virtual machine in the computing machine 20 uses a virtual hard disk (VHD) as an image file. The use of the virtual hard disk is currently published by Microsoft Corporation.

The virtual software 102 manages the virtual hard disk file, which is managed in the operating system executed in the virtual machine 110 as shown in FIG. 3. As shown in FIG. 3, the operating system manages a disk 0 storing a system file therein and a disk 1 storing user data therein.

Disk 0 is a virtual hard disk comprising three virtual hard disk files, i.e., a basic virtual hard disk file 401, a patch differential virtual hard disk file 402, and a PC change differential virtual hard disk file 403. Disk 1 is a virtual hard disk comprising a user data virtual hard disk file 411.

The basic virtual hard disk file 401 is a virtual hard disk file created by the management server, which installs the operating system or applications therein.

The patch differential virtual hard disk file 402 holds a differential from the basic virtual hard disk file 401, and holds differential information when an update program is applied to the virtual hard disk comprising the basic virtual hard disk file 401. The differential information includes change information indicating whether data is changed for each sector of the virtual hard disk comprising the virtual hard disk file, and data stored in the sector whose data is changed.

The PC change differential virtual hard disk file 403 holds differential information for the virtual hard disk comprising the basic virtual hard disk file 401 and the patch differential virtual hard disk file 402. The change information in the PC change differential virtual hard disk file 403 is all set unchanged when the virtual machine is shut down, and the changed data is deleted.

The virtual hard disk (disk 1) comprising the user data virtual hard disk file 411 is mounted as “C:\Users” by Diskpart.exe. Thus, the data on “C:\Users” can be accessed through the virtual disk file containing the basic virtual hard disk file 401 each time the virtual machine is activated.

The basic virtual hard disk file 401, the patch differential virtual hard disk file 402, the PC change differential virtual hard disk file 403, and the user data virtual hard disk file 411 are stored in the management server 11. When the virtual machine 110 is activated, the basic virtual hard disk file 401, the patch differential virtual hard disk file 402, the PC change differential virtual hard disk file 403 and the user data virtual hard disk file 411 are distributed from the management server 11 to the computing machine 20.

The Windows service 112 stores the data beginning with “S-1-5-21” among ProfileList registry on “C:\Users” before the virtual hard disk file constituting the virtual hard disk is distributed. The ProfileList registry has the following path:

HKLM\Software\Microsoft\Windows NT\CurrentVersion\ProfileList

Processing of the Windows service 112 after distribution will be described below with reference to a flowchart of FIG. 5.

The Windows service 112 temporarily clears “C:\Users” after distribution (block 501), and then mounts disk 1 as “C:\Users” (block 502) to recover the ProfileList registry. Thereafter, not only C:\Users but also the Profilelist registry is recovered (block 503) so that the user who has logged onto the computing machine can log on again.

“C:\Users”, that is, the contents of the user data virtual disk file are stored in the management server when the virtual software shuts down the virtual machine, and thus even when the user loses the computing machine outside the office, the data remaining in the lost computing machine can be recovered.

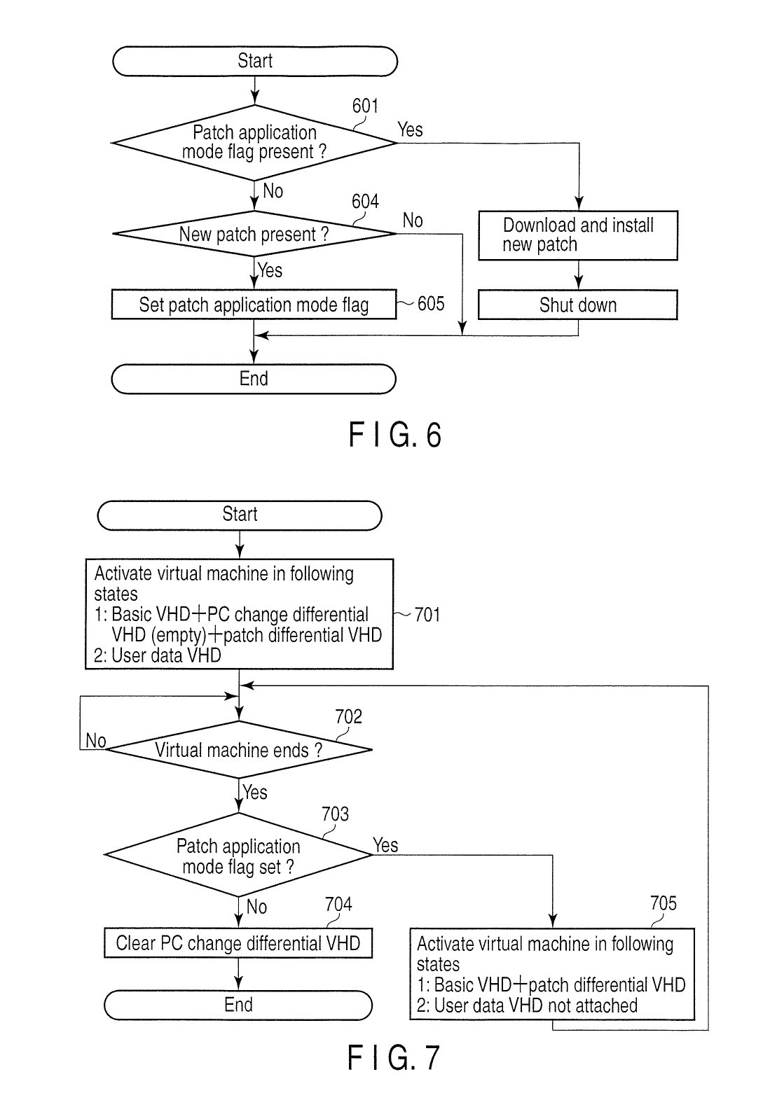

Processing executed in the virtual machine 110 after activation will be described below with reference to a flowchart of FIG. 6.

The Windows service 112 executed in the virtual machine 110 determines whether a patch application mode flag is present (block 601). When it is determined that a “C:\Update” file is present, for example, the Windows service 112 executed in the virtual machine determines that the patch application flag mode is present.

When it is determined that the patch application flag mode is set (Yes in block 601), the Windows service 112 downloads a new update program from the WSUS server 10 and installs the new update program to patch the operating system and/or the application program (block 602). Thereafter, the Windows service 112 shuts down the operating system operating in the virtual machine, and the virtual machine 110 ends (block 603).

When it is determined that the patch application flag mode is not set (No in block 601), the Windows service 112 uses the Windows Update Agent (WUA) API to inquire of the WSUS server 10 about whether a new update program is present. In response to the inquiry result, the Windows service 112 determines whether a new update program is present (block 604). When it is determined that a new update program is present (Yes in block 604), the Windows service 112 sets the patch application mode flag (block 605). The Windows service 112 creates a “C:\Update” file, for example, to set the patch application mode flag.

A procedure of the processing by the virtual software 102 on the activation and end of the virtual machine 110 will be described below with reference to a flowchart of FIG. 7.

The virtual software 102 typically activates the virtual machine by the virtual hard disk comprising the basic virtual hard disk file 401, the patch differential virtual hard disk file 402 and the PC change differential virtual hard disk file 403 as well as the virtual hard disk comprising the user data virtual hard disk file 411 (block 701).

After activation, when the virtual machine 110 ends, the virtual software 102 determines whether the patch application mode flag is set (block 701). The virtual software 102 mounts the PC change differential virtual hard disk file 403, for example, and confirms whether the “C:\Update” file is present, thereby determining whether the patch application mode flag is set.

When it is determined that the patch application mode flag is set (Yes in block 701), the virtual software 102 activates the virtual machine by the virtual hard disk comprising the basic virtual hard disk file 401 and the patch differential virtual hard disk file 402 (block 705). At this time, the virtual software 102 does not attach the virtual hard disk comprising the user data virtual hard disk file 411 to the virtual machine 110. Since the user data virtual hard disk file 411 is not attached, “C:\Users” is empty and cannot be erroneously logged onto by the user.

When it is determined that the patch application flag mode is not set (No in block 703), all the change presence information for each sector in the PC change differential virtual hard disk file 403 is set unchanged and the changed data in the PC change differential virtual hard disk file 403 is deleted (block 704).

As described above, the virtual software 102 performs the processing when the virtual machine 110 is activated and ends.

When the virtual machine 110 ends, a change differential due to the patch application to the basic virtual hard disk file 401 is stored in the patch differential virtual hard disk file 402 and the unwanted PC change differential virtual hard disk file 403 is discarded to delete the change differential in a place other than the set place. The update program application mode is provided so that the change differential of the update program relative to the basic virtual hard disk file 401 can be stored.

### Second Embodiment

There is assumed in the first embodiment the case in which the WSUS server 10 is present. The update program may need a license, and the update program for which the administrator accepts the license in the WSUS server 10 does not need to accept the license in each computing machine.

Since the update program is installed in each computing machine in an unmanned manner in the first embodiment, each computing machine cannot accept the license. Thus, a limit is set on the environment in which the WSUS server is used.

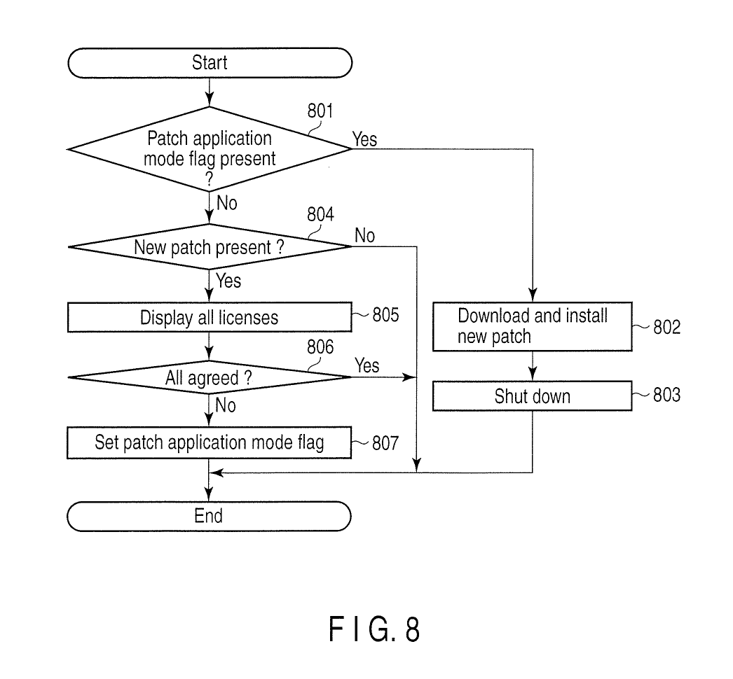

However, an operation processing of a Windows service 112 for enabling an update program to be installed from the Microsoft Update or Windows Update site per computing machine when the WSUS server is not introduced will be described with reference to a flowchart of FIG. 8.

The Windows service 112 executed in a virtual machine determines whether a patch application mode flag is present (block 801). When it is determined that a “C:\Update” file is present (Yes in block 601), the Windows service 112 executed in the virtual machine downloads a new update program from a WSUS server 10 to install the new update program (block 802). Thereafter, the Windows service 112 shuts down an operating system operating in the virtual machine (block 803).

When it is determined that “C:\Update” file is not present (No in block 801), the Windows service 112 uses the Windows Update Agent (WUA) API to inquire of the WSUS server 10 about whether a new update program is present. In response to the inquiry result, the Windows service 112 determines whether a new update program is present (block 804). When it is determined that a new update program is present (Yes in block 804), the Windows service 112 displays the licenses attached to all the update programs on the display (block 805). The Windows service 112 determines whether all the licenses are accepted (block 806). When it is determined that all the licenses are accepted (Yes in block 806), the “C:\Update” file is created to set the patch application mode flag (block 805). When it is determined that all the licenses are not accepted (No in block 806), the Windows service 112 ends the processing without setting the patch application mode flag.

The license of the update program is accepted while the user is operating the computing machine, and thus the update program can be automatically installed even when the WSUS server 10 is not introduced.

### Third Embodiment

A basic virtual hard disk file 401 is created to be distributed to the computing machine. However, the basic virtual hard disk file 401 comprises of a plurality of virtual hard disk files in which a parent hard disk file and a differential hard disk file are combined.

The virtual hard disk file to be distributed is allowed to distribute the parent virtual hard disk file and the differential virtual hard disk file, and thus only the differential virtual hard disk file is distributed so that loads on the network and computing machine are alleviated in a terminal already holding the parent hard disk file.

### Fourth Embodiment

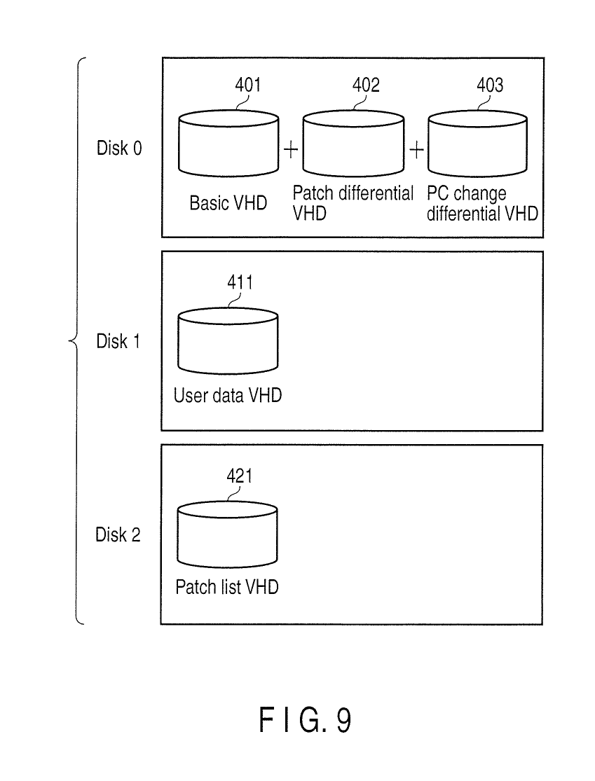

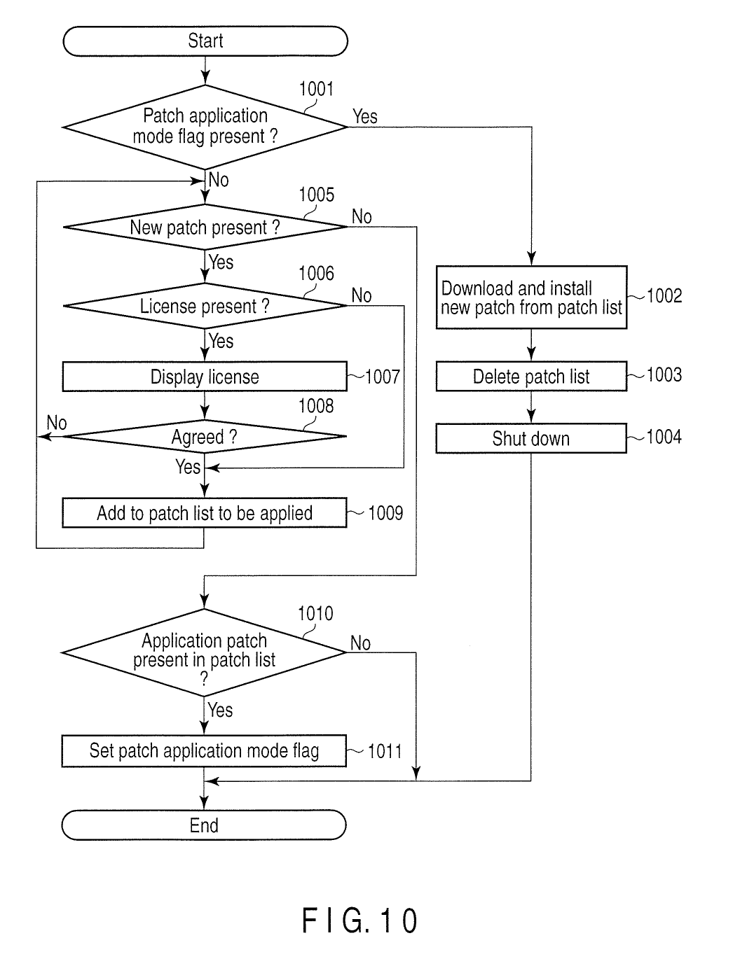

When a WSUS server 10 is not used, as shown in FIG. 9, a virtual hard disk comprising an update program list virtual hard disk file 421 may be added to a disk 2. Processing by a Windows service 112 when disk 2 is added will be described with reference to a flowchart of FIG. 10.

The Windows service 112 executed in a virtual machine determines whether a patch application mode flag is present (block 1001). When it is determined that a “C:\Update” file is present (Yes in block 601), the Windows service 112 executed in the virtual machine downloads a new update program from the WSUS server 10 and installs the new update program (block 1002). The Windows service 112 deletes the update program list (block 1003) and shuts down the operating system operating in the virtual machine (block 1004).

When it is determined that the “C:\Update” file is not present (No in block 1001), the Windows service 112 uses the Windows Update Agent (WUA) API to inquire of the WSUS server 10 about whether a new update program is present. In response to the inquiry result, the Windows service 112 determines whether there is a new update program which is not listed in the update program list or whose license is not confirmed (block 1005). When it is determined that there is a new update program which is not listed in the update program list or whose license is not confirmed (Yes in block 1004), the Windows service 112 selects one new update program from the new update programs which are not installed and whose licenses are not confirmed, and determines whether the selected new update program has the license (block 1006).

When it is determined that the license is not present (No in block 1006), the Windows service 112 adds the selected new update program to the update program list (block 1009). When it is determined that the license is present (Yes in block 1006), the Windows service 112 displays the license of the selected new update program on the display (block 1007). After the user accepts or does not accept, the Windows service 112 determines whether the user accepts (block 1008). When it is determined that the user accepts (Yes in block 1008), the Windows service 112 adds the selected new update program to the update program list (block 1009).

In block 1005, when it is determined that there is not a new update program which is not listed in the update program list or whose license is not confirmed (No in block 1005), the Windows service 112 determines whether an application update program is present in the update program list (block 1010). When it is determined that an application update program is present (Yes in block 1010), the Windows service 112 sets the patch application mode flag (block 1011).

The update program list is newly written as a file in disk 2. The knowledge base (KB) numbers are written in the update program list every line as follows:

KBxxxxxx

KByyyyyy

In the patch application mode, only the update program files having the KB numbers described in the file are downloaded and installed.

In the present embodiment, the license is accepted per update program so that only the accepted program and the program not required to be accepted can be installed.

The various modules of the systems described herein can be implemented as software applications, hardware and/or software modules, or components on one or more computing machines, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A computing machine comprising:
an activation module configured to activate, in a first mode, a virtual machine using a first virtual storage comprising a basic virtual storage file, an update differential virtual storage file, and a change differential virtual storage file,
the basic virtual storage file including first data for executing an operating system and/or an application executed in the virtual machine,
the update differential virtual storage file including differential information comprising updating data for updating the operating system and/or the application and updating portion data indicating a first changed portion of the basic virtual storage file which is changed by the updating data, and
the change differential virtual storage file comprising changing data and changed portion data indicating a second changed portion of the basic virtual storage file and the update differential virtual storage file which is changed by the changing data;
a allocating module configured to allocate a second virtual storage comprising a data storage virtual storage file to the virtual machine; and
a changing module configured to change the updating portion data to unchanged portion data indicating a unchanged portion of the basic virtual storage file when the virtual machine is terminated, and to delete the updating data from the differential information.

2. The computing machine of claim 1, wherein the activation module is configured to activate, in a second mode, the virtual machine using a third virtual storage comprising the basic virtual storage file and the update differential virtual storage file.

3. The computing machine of claim 2, further comprising:
a record module configured to acquire an update program for updating the operating system and/or the application to update the operating system and/or application, and to record updating data and the updating portion data in the differential information.

4. The computing machine of claim 1, further comprising:
the record module is configured to inquire whether user accepts executing of the update program, and execute the update program when the user accepts executing of the update program.

5. A method for controlling a computing machine, comprising:
activating, in a first mode, a virtual machine using a first virtual storage comprising a basic virtual storage file, an update differential virtual storage file, and a change differential virtual storage file,
the basic virtual storage file including first data for executing an operating system and/or an application executed in the virtual machine,
the update differential virtual storage file including differential information comprising updating data for updating the operating system and/or the application and updating portion data indicating a first changed portion of the basic virtual storage file which is changed by the updating data, and
the change differential virtual storage file including changing data and changed portion data indicating a second changed portion of the basic virtual storage file and the update differential virtual storage file which is changed by the changing data;
allocating a second virtual storage comprising a data storage virtual storage file to the virtual machine;
prohibiting the data in the basic virtual storage file and the update differential virtual storage file from being changed; and
changing the changed portion data to unchanged portion data indicating a unchanged portion when the virtual machine is terminated, and deleting the updating data from the differential information.

6. The method of claim 5, further comprising:
activating the virtual machine, in a second mode, using a third virtual storage comprising the basic virtual storage file and the update differential virtual storage file.
